(19) United States
(12) Patent Application Publication
(10) Pub. No.: US 2012/0292410 A1
(43) Pub. Date: Nov. 22, 2012

(54) NOZZLE ASSEMBLY FOR SPRAY APPARATUS

(75) Inventors: Ying-Shu CHEN, Shindian (TW); Xiao-Gang ZHANG, Shenzhen City (CN); Bing YU, Shenzhen City (CN)

(73) Assignees: FIH (Hong Kong) Limited, Kowloon (HK); SHENZHEN FUTAIHONG PRECISION INDUSTRY CO., LTD., ShenZhen City (CN)

(21) Appl. No.: 13/284,685

(22) Filed: Oct. 28, 2011

(30) Foreign Application Priority Data
May 20, 2011 (CN) 201120162927.7

(51) Int. Cl. B05B 1/14

(52) U.S. Cl. 239/548

(57) ABSTRACT

A nozzle assembly includes a first tube, a second tube and a number of nozzles. The second tube communicates with the first tube. The nozzles are positioned on the second tube, and communicate with the second tube. The nozzles are positioned in staggered rows.

### CROSS-REFERENCE TO RELATED APPLICATIONS

This application is one of the four related co-pending U.S. patent applications listed below. All listed applications have the same assignee and were concurrently filed herewith. The disclosure of each of the listed applications is incorporated by reference into all the other listed applications.

| Attorney | | |
|---|---|---|
| Docket No. | Title | Inventors |
| US39180 | AIR KNIFE MODULE | Chen et al. |
| US39181 | NOZZLE ASSEMBLY FOR SPRAY | Chen et al. |
| | APPARATUS | |
| US39182 | AIR DRYING APPARATUS | Chen et al. |
| US39183 | CLEANING AND DRYING APPARATUS | Chen et al. |

### BACKGROUND

1. Technical Field

The present disclosure generally relates to spray apparatus, and particularly to a nozzle assembly applied in a spray apparatus.

2. Description of Related Art

Spray apparatuses usually include a nozzle assembly for spraying liquid onto surfaces. The nozzle assembly includes a number of nozzles. The nozzles are arranged along a line. Thus, the spraying head has to be long enough to accommodate these nozzles. If the number of the nozzles is reduced in order to achieve the miniaturization of the spraying head, the spraying volume of the spraying head is reduced.

Therefore, there is room for improvement within the art.

### BRIEF DESCRIPTION OF THE DRAWINGS

Many aspects of the nozzle assembly can be better understood with reference to the following drawings. The components in the drawings are not necessarily to scale, the emphasis instead being placed upon clearly illustrating the nozzle assembly. Moreover, in the drawings, like reference numerals designate corresponding parts throughout the several views.

FIG. 1 is a schematic view of a spray apparatus according to an exemplary embodiment.

FIG. 2 is a cross-sectional view of the spray apparatus taken along line II-II of FIG. 1.

FIG. 3 is a schematic view of a nozzle assembly of the spray apparatus in FIG. 1.

### DETAILED DESCRIPTION

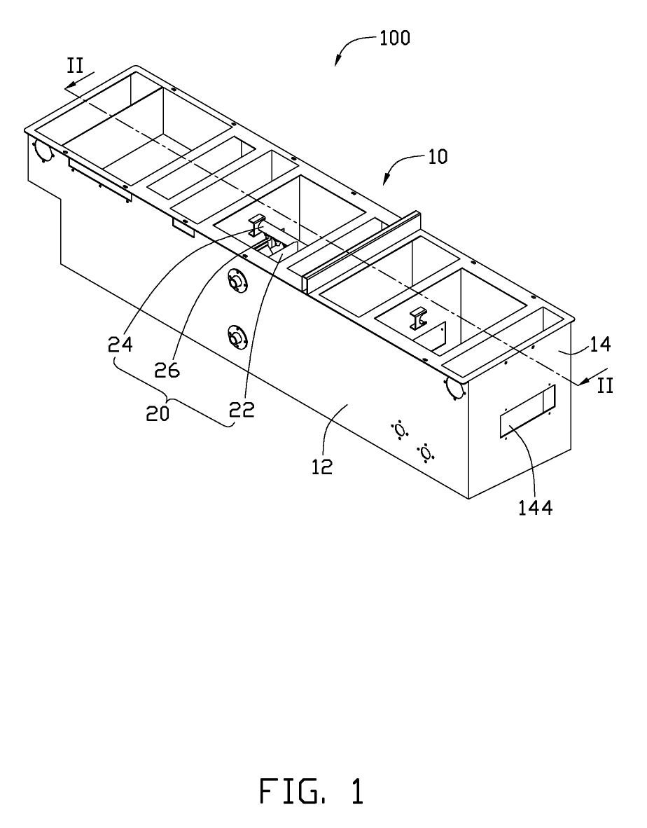

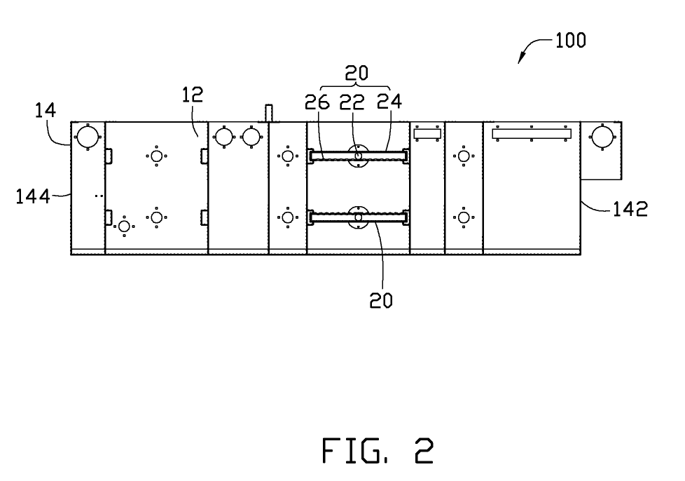

FIGS. 1 and 2 show an exemplary embodiment of a spray apparatus 100. The spray apparatus 100 includes a main body 10 and two opposite nozzle assemblies 20 mounted in the main body 10.

The main body 10 includes opposite sidewalls 12 and opposite end walls 14. The nozzle assemblies 20 are mounted on the sidewalls 12. One of the end walls 14 defines an entrance 142, and the other end wall 14 defines an exit 144. Objects may be transported on conveyor belts (not shown) to enter through the entrance 142, and exit from the exit 144.

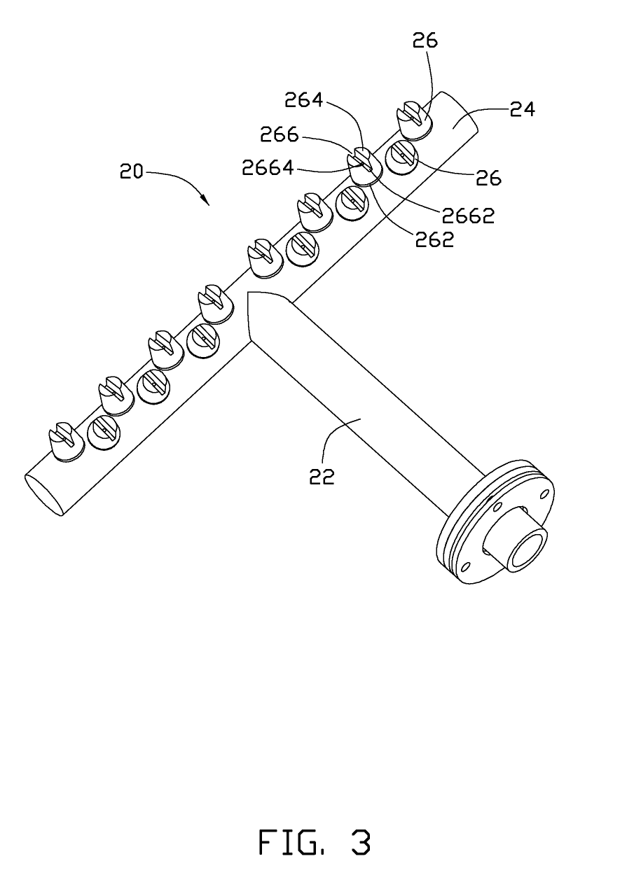

Referring to FIG. 3, each nozzle assembly 20 includes a first tube 22, a second tube 24, and a number of nozzles 26. The first tube 22 is mounted to one of the sidewalls 12, and is configured to connect to a supply of spraying liquid. The second tube 24 communicates with the first tube 22 for allowing the spraying liquid to enter the second tube 24. In this exemplary embodiment, the second tube 24 is perpendicular to the first tube 22. The nozzles 26 communicate with the second tube 24. In this exemplary embodiment, the nozzles 26 are arranged in two staggered rows, and each three adjacent nozzles 26 are not in the same row.

Each nozzle 26 includes a first end 262 and an opposite second end 264. The second end 262 defines a guide groove 266 and a through hole 2664. The through hole 2664 is defined in a bottom surface 2662 in the guide groove 266. The through hole 2664 communicates with the second pipe 24. The guide groove 266 is configured for guiding the sprayed liquid to eject.

In assembly, the nozzle assemblies 20 are respectively mounted to the sidewalls 12. The two nozzle assembles 20 are positioned with each other. Each nozzle 26 of one nozzle assembles 20 is aligned with that of the other nozzle assembly 20.

In use, the first tubes 22 of the nozzle assemblies 20 are connected to the supply of spraying liquid (not shown), the nozzle assemblies 20 are turned on. The objects enter through the entrance 142 between the nozzle assembles 20. The nozzles 26 spay liquid onto two sides of the objects. Since the nozzles 26 are in two staggered rows, the number of the nozzle 26 may be increased for improving spraying volume without increasing the length of the nozzle assembly 20. After the objects are sprayed, they can be driven to exit through the exit 144.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A nozzle assembly comprising:
a first tube;
a second tube communicating with the first tube; and
a number of nozzles positioned on the second tube, and communicating with the second tube;
wherein the nozzles are arranged in staggered rows.

2. The nozzle assembly as claimed in claim 1, wherein the second tube is perpendicular to the first tube.

3. The nozzle assembly as claimed in claim 2, wherein the nozzles are arranged in two rows, and each three adjacent nozzles are not in the same row.

4. The nozzle assembly as claimed in claim 2, wherein each nozzle includes a first end and an opposite second end, the second end defines a guide groove and a through hole, the through hole is defined in a bottom surface in the guide groove, and the through hole communicates with the second pipe.

5. A spraying apparatus comprising:
a main body;
at least one nozzle assembly mounted in the main body, the nozzle assembly comprising:
a first tube;
a second tube communicating with the first tube; and
a number of nozzles positioned on the second tube, and communicating with the second tube;
wherein the nozzles are arranged in staggered rows.

6. The spraying apparatus as claimed in claim 5, wherein there are two nozzle assemblies, and the two assemblies are positioned with each other.

7. The spraying apparatus as claimed in claim 5, wherein the second tube is perpendicular to the first tube.

8. The spraying apparatus as claimed in claim 7, wherein the nozzles are arranged in two rows, and each three adjacent nozzles are not in the same row.

9. The spraying apparatus as claimed in claim 5, wherein each nozzle includes a first end and an opposite second end, the second end defines a guide groove and a through hole, the through hole is defined in a bottom surface in the guide groove, and the through hole communicates with the second pipe.
